(19) United States
(12) Patent Application Publication
(10) Pub. No.: US 2007/0001470 A1
(43) Pub. Date: Jan. 4, 2007

(54) Motor vehicle pneumatic bumper

(76) Inventor: Bruce M. Schwalm, Livonia, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/082,235

(22) Filed: Mar. 16, 2005

Related U.S. Application Data
(63) Continuation of application No. PCT/US02/23178, filed on Sep. 16, 2002.

(51) Int. Cl. B60R 19/20; B60K 28/10

(52) U.S. Cl. 293/107; 180/274

(57) ABSTRACT

A vehicle bumper comprising a pneumatic cushion comprising a gas inlet, a gas outlet, a rear support portion and an impact portion, the rear support portion being thicker than the impact portion. The bumper also includes an inflation means configured for a gas to enter the pneumatic cushion through the gas inlet wherein the inflation means comprises a gas inlet valve and a deflation means configured for the gas to exit the pneumatic cushion through the gas outlet, the deflation means comprising a pressure relieve valve.

### CROSS REFERENCE TO RELATED APPLICATIONS

This application is a continuation of International Application No. PCT/US02/23178 filed Sep. 16, 2002 and published Jun. 17, 2004 as International Publication No. WO 2004/050423, designating the United States.

### FIELD OF THE INVENTION

This invention generally relates to a motor vehicle bumper and, more particularly, to a pneumatic bumper which deflates in response to compression thereof and may there after be reinflated.

### BRIEF DESCRIPTION OF THE DRAWINGS

FIG. 1 is a representative perspective view of a bumper according to the present invention; and

FIG. 2 is a cross-sectional view of FIG. 1 taken along line 2-2.

FIG. 3 is an enlarged partial sectional view of circled section 3 of FIG. 2.

The above and other objects, feature, and advantages of the present invention will be apparent in the following detailed description thereof when read in conjunction with the appended drawings wherein the same reference characters denote the same or similar parts throughout the several views.

### DESCRIPTION OF THE INVENTION

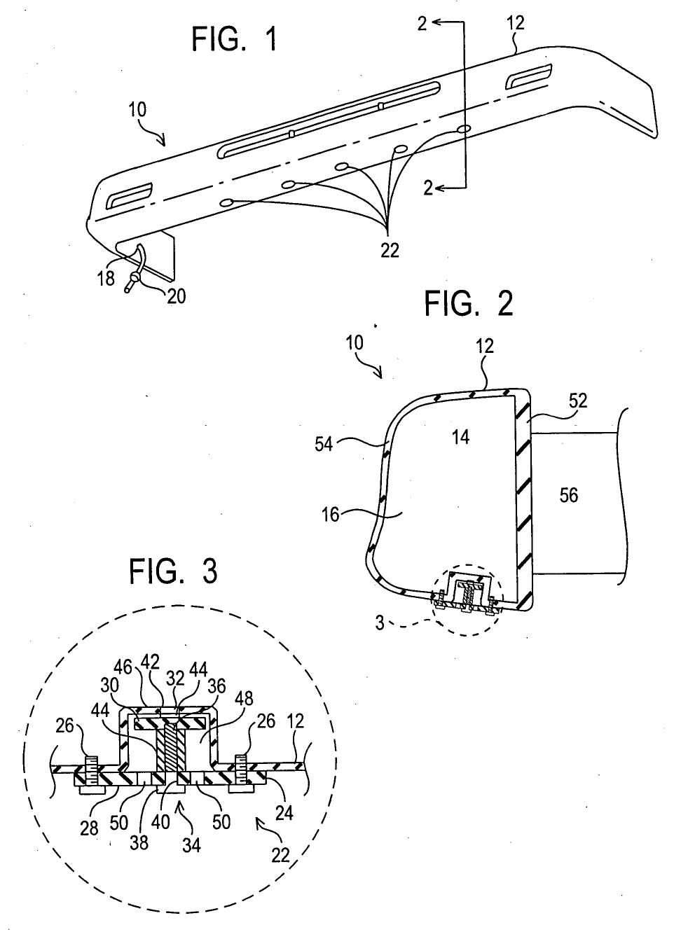

An exemplary bumper according to the present invention which may be attached to a wheeled motor vehicle is shown in FIG. 1 at reference character 10. Bumper 10 comprises a pneumatic cushion 12 having a cavity 14 filled with gas 16 and preferably made of a polymer material, such as a thermoplastic. Pneumatic cushion 12 is preferably formed via blow molding.

In order to fill pneumatic cushion 12 with gas 16, pneumatic cushion 12 preferably comprises one or more gas inlets 18 with an inflation means configured for gas 16 to enter pneumatic cushion 12 through gas inlet 18, such as an inflation valve 20. Preferably the gas 16 comprises air and the pressure within the pneumatic cushion 12 is maintained at a predetermined set point when the bumper is inflated. More preferably, the pressure within the pneumatic cushion 12 may be observed from a gauge visible to the motor vehicle's driver during use, such as on the instrument panel or part of another information display.

In response to being compressed, such as by an inwardly directed force in response to a vehicle impact or collision, pneumatic cushion 12 preferably comprises one or more gas outlets 32 with a deflation means configured for gas 16 to exit pneumatic cushion 12 through gas outlet 32, such as a pressure relief valve 22.

With the onset of compression, the pressure within pneumatic cushion 12 begins to rise. Upon reaching a predetermined relief pressure, relief valve 22 opens to release at least a portion of the gas 16 contained within pneumatic cushion 12. Thus, relief valve 22 performs the function of managing motor vehicle impact forces when the pressure inside the cushion 12 initially increases sharply by reducing the forces with a corresponding decrease on the gas 16 pressure within the pneumatic cushion 12. Moreover, after some of the gas 16 is released, the pneumatic cushion 12 can be further compressed until the preset pressure of the relief valve 22 is again reached, thus performing a further energy absorbing function.

As shown in FIG. 3, relief valve 22 comprises a mounting member 24, preferably in the form of a circular plate. As shown, mounting member 24 is attached to pneumatic cushion 12 of bumper 10 by fastening means 26 extending through mounting member 24 from the outer surface 28 and into connection with pneumatic cushion 12. As shown, fastening means 26 comprises threaded fasteners, but also may comprise other mechanical fasteners or adhesives, a weld joint, etc.

Relief valve 22 further comprises a sealing member 30 which normally seals gas outlet 32 of pneumatic cushion 12 against the flow of pressurized gas 16 therefrom contained therein. As shown, sealing member 30 preferably comprises a circular plate. Also preferably, a sealing gasket 46, such as an o-ring, is disposed between sealing member 30 and pneumatic cushion 12.

As shown, mounting member 24 and sealing member 30 are interconnected by a centrally disposed connecting means 34. Connecting means 34 preferably comprises a circular shaft 36 with a circular head portion 38. More preferably, connecting means comprises a round head cap screw.

More specifically, shaft 36 of connecting means 34 preferably slideably extends through an aperture 40 in mounting member 24 and thereafter, preferably the distal end 42, threadably engages a blind hole receptacle 44 formed in sealing member 30. Also preferably, head portion 38 of connecting means 34 comprises a larger diameter than aperture 40 thus preventing connecting means 34 from completely extending through aperture 40 and forming a mechanical engagement between head portion 38 of connector means 34 and outer surface 28 of mounting member 24.

During assembly of mounting member 24 and sealing member 30 by connector member 34, preferably the shaft 36 of connecting member 34 also extends though a spring 44 disposed between mounting member 24 and sealing member 30. Also preferably, after assembly of mounting member 24 and sealing member 30 by connector member 34, the spring 44 is placed in compression.

With regards to operation, as pneumatic cushion 12 is compressed and the pneumatic pressure within increases, the pressure eventually overcomes the biasing sealing force placed on sealing member 30 by compressed spring 44. Thus, the pneumatic pressure forces sealing member 30 to retract away from gas outlet 32, thus allowing gas 16 to exit from pneumatic cushion 12.

As shown in FIG. 3, a portion of relief valve 22 is located within a circular receptacle 48 of pneumatic cushion 12. In order to prevent any associated pressure increase in receptacle 48 with the release of gas 16 from pneumatic cushion 12 through gas oulet 32, and possibly dislodge relief valve 22 from pneumatic cushion 12, preferably mounting member 24 is provided with at least on aperture 50 which allows gas 16 to exit from receptacle 48.

The sealing force provide by spring 44 for sealing aperture 32 may be controlled by adjusting the spring constant K of spring 44. For example, increasing the spring constant K, and the associated biasing force applied against the opening of gas outlet 32, may be related to correlate with the functional design limits, such as impact speed (e.g. 2.5 miles per hour (mph), 5.0 mph, 10 mph) or impact force, of the bumper 10.

As shown in FIG. 2, preferably pneumatic cushion 12 of bumper 10 comprises a varying cross-sectional thickness, with the rear support portion 52 of the pneumatic cushion 12, configured to have a thickness greater than the outer impact portion 54 of the pneumatic cushion 12. In this manner rear support portion 52 of pneumatic cushion 12 may be configured to direct collision forces to the chassis of a motor vehicle, such as the frame rails 56, and function as a bumper beam or other vehicle cross-member without the need for a separate bumper beam or supporting cross-member located there between to function as a support structure. Furthermore, the thinner cross-section of impact portion 54 reduces the section modulus of the impact portion 54, thus making the impact portion 54 more flexible and less apt to develop a crease or other permanent indentation which cannot be removed upon reinflation of the pneumatic cushion 12. In order to vary the cross-sectional thickness of pneumatic cushion 12, with the use of extrusion blow molding, the die may be provided with a profile as shown in FIG. 2.

Thus, the bumper 10 according to the invention possesses an effective energy absorbing ability. When the motor vehicle collides with any obstacles, as the inflated pneumatic cushion 12 is compressed, it greatly absorbs the kinetic energy of the vehicle and thus reduces the impact forces acting on the vehicle.

Preferably, pneumatic cushion 12 is sufficiently rigid to maintain shape of the bumper 10 and to be self-supporting upon installation and with use in the vehicle. Furthermore, preferably pneumatic cushion 12 is sufficiently rigid to direct and transfer impact energy and associated forces to the motor vehicle chassis or frame directly, without the need for a separately formed reinforcing structure such as, for example, a bumper base or beam located between the pneumatic cushion 12 and the chassis/frame. In other words, preferably the kinetic energy and impact forces associated with a collision are transferred directly from the pneumatic cushion 12 directly to the chassis/frame of the motor vehicle, and not through a separate bumper beam located in between.

Also, in other embodiments, the pressure within pneumatic cushion 12 may be a function of vehicle speed (e.g. linear, proportional, inverse). Preferably, as vehicle speed increases, pneumatic pressure within pneumatic cushion 12. Also in other embodiments, preferably the rate of gas discharge through relief valve 22 is also a function of vehicle speed, with the rate of discharge increasing as the speed of the vehicle increases. Also, in other embodiments, preferably the relief pressure of the relief valve 22 is calibrated not to open and release gas until the vehicle speed exceeds a certain predetermined minimum speed threshold value, which is preferably equates to the design limitations of the bumper 10 such as 2.5, 5.0 and 10.0 mph.

The description and drawings illustratively set forth our presently preferred invention embodiments. We intend the description and drawings to describe these embodiments and not to limit the scope of the invention. Those skilled in the art will appreciate that still other modifications and variations of the present invention are possible in light of the above teaching while remaining within the scope of the following claims. Therefore, within the scope of the claims, one may practice the invention otherwise than as the description and drawings specifically show and describe.

What is claimed is:

1. A vehicle bumper comprising:
a pneumatic cushion comprising a gas inlet, a gas outlet, a rear support portion and an impact portion, the rear support portion being thicker than the impact portion;
an inflation means configured for a gas to enter the pneumatic cushion through the gas inlet; the inflation means comprising a gas inlet valve; and
a deflation means configured for the gas to exit the pneumatic cushion through the gas outlet; the deflation means comprising a pressure relieve valve.

2. The vehicle bumper of claim 1 wherein the deflation means is preset to manage motor vehicle impact forces at a predetermined vehicle speed.

3. The vehicle bumper of claim 1 wherein the pneumatic cushion comprises a thermoplastic.

4. The vehicle bumper of claim 1 wherein the pneumatic cushion is formed by blow molding.

5. The vehicle bumper of claim 1 wherein the pneumatic cushion can be divided into sections with said sections having a gas inlet valve and a gas outlet valve wherein each section can be inflated to a different pressure than an adjacent section.

6. The vehicle bumper of claim 1 wherein outer impact portion is thinner in cross-section than the rear support portion.

7. The vehicle bumper of claim 1 wherein the outlet valve is calibrated to open above a predetermined minimum vehicle speed.

8. The vehicle bumper of claim 1 wherein the gas pressure within said pneumatic cushion is increased as a function of the speed of the vehicle.

9. A reinflatable vehicle bumper comprising:
a pneumatic cushion comprising a gas inlet, a gas outlet a rear support portion and an impact portion, the rear support portion being thicker than the impact portion;
an inflation means configured for a gas to enter the pneumatic cushion through the gas inlet, the inflation means comprising a gas inlet valve; and
a deflation means configured for the gas to exit the pneumatic cushion through the gas outlet, the deflation means comprising a pressure relieve valve, wherein said pneumatic cushion can be reinflated after being impacted and deflated.
